(19) United States
(12) Patent Application Publication
(10) Pub. No.: US 2020/0089043 A1
(43) Pub. Date: Mar. 19, 2020

(54) ELECTRO-OPTICAL DEVICE AND ELECTRONIC APPARATUS

(71) Applicant: SEIKO EPSON CORPORATION, Tokyo (JP)

(72) Inventors: Minoru MORIWAKI, Matsumoto-shi (JP); Norio NAKAMURA, Matsumoto-shi (JP)

(73) Assignee: SEIKO EPSON CORPORATION, Tokyo (JP)

(21) Appl. No.: 16/568,377

(22) Filed: Sep. 12, 2019

(30) Foreign Application Priority Data
Sep. 13, 2018 (JP) 2018-171588

(51) Int. Cl. G02F 1/1333; G03B 21/00; G03B 21/16

(52) U.S. Cl. CPC G02F 1/133382; G02F 1/1333; G03B 21/006; G03B 33/12; G02F 2001/133302; G02F 2001/133354; G03B 21/16

(57) ABSTRACT

A liquid crystal panel of an electro-optical device includes a first quartz substrate, a second quartz substrate facing the first quartz substrate, a liquid crystal layer interposed between the first quartz substrate and the second substrate, a first sapphire substrate bonded to the first quartz substrate, and a second sapphire substrate bonded to the second quartz substrate. Each thickness of the first sapphire substrate and the second sapphire substrate is at least two times a thickness of the first quartz substrate or the second quartz substrate.

The present application is based on, and claims priority from JP Application Serial Number 2018-171588, filed Sep. 13, 2018, the disclosure of which is hereby incorporated by reference herein in its entirety.

### BACKGROUND

### 1. Technical Field

The present disclosure relates to an electro-optical device and an electronic apparatus.

### 2. Related Art

In recent years, liquid crystal projectors have become widespread as devices that display a large picture plane on a screen. The liquid crystal projector is configured to split light from a light source into red, green, and blue of three primary colors, assign and transmit light of each color to each liquid crystal panel, synthesize a transmitted image of each color, enlarge the transmitted image by an optical system such as a lens, and project the transmitted image onto a screen and the like.

In the liquid crystal projector, high brightness of an image to be projected is generally required, thus the amount of light incident on the liquid crystal panel needs to be increased in order to increase the brightness. When the amount of incident light is increased, heat generation of the liquid crystal panel is problematic. Thus, a technology for promoting heat dissipation by providing a sapphire substrate on a light incident surface on a side of the liquid crystal panel on which light is incident or a light emitting surface on a side from which light is emitted has been proposed (see, for example, JP-A-2003-195421).

One of main heat generation sources in the liquid crystal panel is a black matrix (BM) in an element substrate. Since a thin film transistor, a pixel electrode, and the like are formed on the element substrate of the liquid crystal panel, a quartz substrate capable of withstanding a high-temperature polysilicon manufacturing process at 800° C. or higher is used. However, the quartz substrate has relatively low thermal conductivity. Thus, the inventor of the specification has found that even in a case where a sapphire substrate having relatively high thermal conductivity is simply provided on the light incident surface or the light emitting surface of the liquid crystal panel, a heat dissipation effect is sometimes insufficient.

### SUMMARY

In order to solve one of the above-described problems, an electro-optical device according to one aspect of the present disclosure includes a first quartz substrate, a second quartz substrate facing the first quartz substrate, a liquid crystal layer interposed between the first quartz substrate and the second substrate, a first sapphire substrate bonded to the first quartz substrate, and a second sapphire substrate bonded to the second quartz substrate. The first sapphire substrate have a thickness greater than or equal to a thickness of two times a thickness of the first quartz substrate and the second sapphire substrate have a thickness greater than or equal to two times a thickness of the second quartz substrate.

### BRIEF DESCRIPTION OF THE DRAWINGS

FIG. 1 is a diagram illustrating a liquid crystal projector using an electro-optical device.

FIG. 2 is a perspective view illustrating an overall configuration of the electro-optical device.

FIG. 3 is a diagram illustrating a configuration of a liquid crystal panel according to a first exemplary embodiment.

FIG. 4 is a diagram illustrating a configuration of the liquid crystal panel according to the first exemplary embodiment.

FIG. 5 is an exploded view of a configuration of the electro-optical device.

FIG. 6 is an end view illustrating a configuration of the electro-optical device.

FIG. 7 is a diagram illustrating a configuration of a liquid crystal panel according to a second exemplary embodiment.

FIG. 8 is a diagram illustrating a configuration of the liquid crystal panel according to the second exemplary embodiment.

FIG. 9 is a diagram comparing materials of substrates in the liquid crystal panel according to an exemplary embodiment and the like.

FIG. 10 is a diagram comparing thicknesses of substrates in the liquid crystal panel according to an exemplary embodiment and the like.

### DESCRIPTION OF EXEMPLARY EMBODIMENTS

Hereinafter, modes for carrying out the present disclosure will be described with reference to accompanying drawings.

### First Exemplary Embodiment

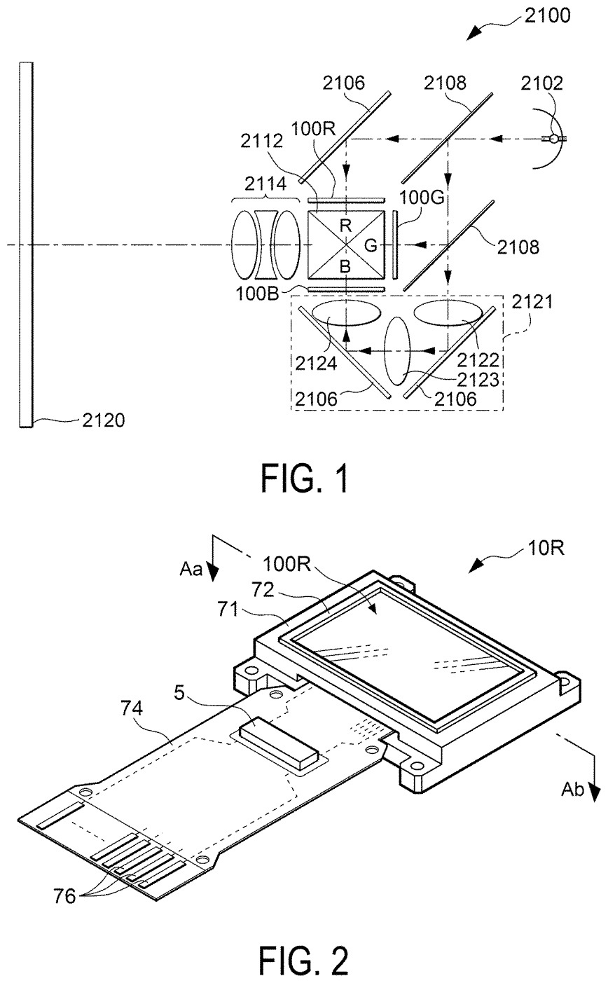

FIG. 1 is a diagram illustrating a configuration of a liquid crystal projector to which an electro-optical device according to a first exemplary embodiment is applied.

As illustrated in FIG. 1, a liquid crystal projector 2100 includes transparent type liquid crystal panels 100R, 100G, and 100B. A lamp unit 2102 including a white light source such as a halogen lamp is provided inside the projector 2100. Projection light emitted from this lamp unit 2102 is split into three primary colors of red, green, and blue by three mirrors 2106 and two dichroic mirrors 2108 installed inside. Of the light of the primary colors, red light, green light, and blue light are incident on the liquid crystal panel 100R, the liquid crystal panel 100G, and the liquid crystal panel 100B, respectively.

Note that an optical path of the blue light is longer than that of red and green. Thus, the blue light is guided to the liquid crystal panel 100B via a relay lens system 2121 formed of an incidence lens 2122, a relay lens 2123, and an emission lens 2124 to prevent a loss due to the optical path.

The liquid crystal panel 100R writes a data signal of a red component supplied from an upper circuit (not illustrated) to each pixel by a built-in driving circuit. In the liquid crystal panel 100R, when a data signal is written to a pixel, the liquid crystal panel 100R come to be in a transmittance according to the data signal. Thus, in the liquid crystal panel 100R, a transmittance for the incident red light is controlled for each pixel, and thus a transmitted image of a red component of images to be displayed is generated.

Similarly, in the liquid crystal panels 100G and 100B, a data signal of a green component and a data signal of a blue component are written to each pixel by the driving circuit, and a transmitted image of the green component and a transmitted image of the blue component of respective images to be displayed are generated.

The transmitted image of each color generated by each of the liquid crystal panels 100R, 100G, and 100B is incident on a dichroic prism 2112 from three directions. Then, at this dichroic prism 2112, the light of R and the light of B are refracted at 90 degrees, whereas the light of G travels in a straight line. Accordingly, the images of the respective colors are synthesized, and subsequently a color image is projected on a screen 2120 by a projection lens 2114.

Note that while the transmitted image by each of the liquid crystal panels 100R and 100B is projected after being reflected by the dichroic prism 2112, the transmitted image by the liquid crystal panel 100G travels in a straight line and is projected. Thus, the transmitted image of each of the liquid crystal panels 100R and 100B has a left-right inverted relationship with respect to the transmitted image of the liquid crystal panel 100G.

The liquid crystal panels 100R, 100G, and 100B only differ in color of incident light, and have the same structure. Thus, the liquid crystal panels 100R, 100G, and 100B are described by taking the liquid crystal panel 100R as an example.

FIG. 2 is a perspective view illustrating an overall configuration of an electro-optical device 10R including the liquid crystal panel 100R. As illustrated in FIG. 2, the liquid crystal panel 100R is housed in a case 71 including an opening.

The liquid crystal panel 100R includes an element substrate and a counter substrate as described later, and one end of an FPC substrate 74 is coupled to the element substrate. Note that FPC is an abbreviation for Flexible Printed Circuit. Further, a plurality of terminals 76 are provided on the other end of the FPC substrate 74 and coupled to the above-described upper circuit. A control circuit 5 of a semiconductor chip is mounted on the FPC substrate 74. A video signal and a synchronization signal are supplied to the FPC substrate 74 from the upper circuit via the plurality of terminals 76. The video signal defines a gray scale level of an image of the R component of images to be displayed by, for example, 8 bits for each R pixel.

The control circuit 5 converts the video signal into an analog data signal suitable for driving the liquid crystal, and also generates a control signal for controlling the driving circuit based on the synchronization signal, and supplies the control signal together with the data signal to the element substrate of the liquid crystal panel 100R.

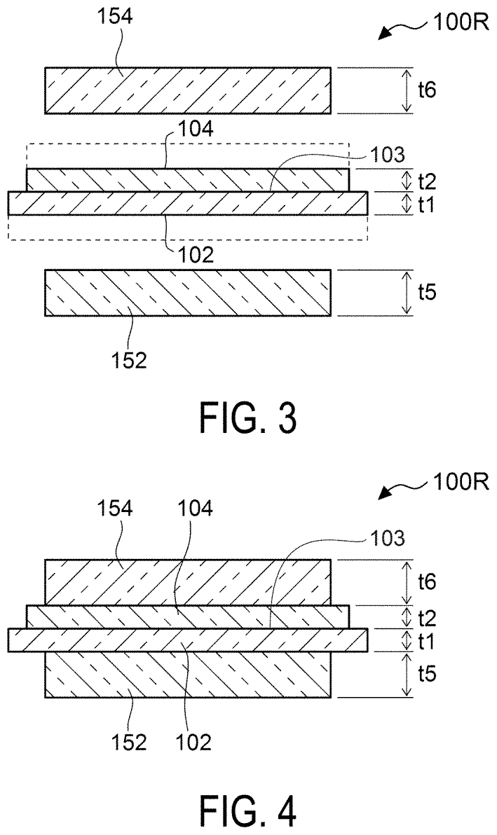

FIGS. 3 and 4 are cross-sectional views illustrating a structure of the electro-optical device 10R in FIG. 2 when the liquid crystal panel 100R except for the case 71 is broken at an Aa-Ab line.

As illustrated in FIG. 3, in the liquid crystal panel 100R, first, an element substrate 102 and a counter substrate 104 are configured to be bonded together. Specifically, a pixel electrode, a thin film transistor, and the like are formed on the element substrate 102, and a counter electrode, a lens array, and the like are formed on the counter substrate 104. Then, the element substrate 102 and the counter substrate 104 are configured such that a constant gap is maintained by a seal material including a spacer, inner side surfaces on which the electrodes are formed are bonded together to face each other, and a liquid crystal layer 103 is sandwiched in the gap between the inner side surfaces. Note that the gap is on the order of several micrometers and is sufficiently thin compared to a thickness on the order of millimeters of the counter substrate 104 and the element substrate 102. Thus, in FIG. 3 and in FIGS. 4 to 8 described later, the element substrate 102 and the counter substrate 104 are expressed in a state of close contact.

Note that, as described later, a quartz substrate is used for each of the element substrate 102 and the counter substrate 104, and thus the element substrate 102 is one example of a first quartz substrate, and the counter substrate 104 is one example of a second quartz substrate.

The element substrate 102 includes a region that projects with respect to the counter substrate 104, and one end of the FPC substrate 74 in FIG. 2 is coupled to this region.

Further, after the element substrate 102 and the counter substrate 104 are bonded together, a light emitting surface on a light emitting side, which is an outer side surface of the element substrate 102, and a light incident surface on a light incident side, which is an outer side surface of the counter substrate 104, are each thinned by cutting, polishing, or the like from a state indicated by broken lines in FIG. 3 to a state indicated by solid lines.

In the liquid crystal panel 100R, secondly, in a state where the element substrate 102 and the counter substrate 104 are bonded together and thinned, a heat dissipation substrate 152 and a heat dissipation substrate 154 are configured to be respectively bonded to the light emitting surface of the element substrate 102 and the light incident surface of the counter substrate 104, further as illustrated in FIG. 4.

Note that bonding represents a state where the element substrate 102 and the counter substrate 104 are disposed such that heat of the element substrate 102 or the counter substrate 104 can be conducted to the heat dissipation substrate 152 or 154 in a case where the element substrate 102 and the heat dissipation substrate 152, or the counter substrate 104 and the heat dissipation substrate 154 are disposed to adhere to each other via an adhesive material, or in a case where only peripheral regions are adhered to each other with the adhesive material and central portions are disposed to be bonded together via a heat conduction member, or in a case where the element substrate 102 and the heat dissipation substrate 152 are disposed in direct contact without interposing an adhesive material and a heat conduction member, and the like.

As described later, a sapphire substrate is used for each of the heat dissipation substrates 152 and 154, and thus the heat dissipation substrate 152 is one example of a first sapphire substrate, and the heat dissipation substrate 154 is one example of a second sapphire substrate.

In FIGS. 3 and 4, light is incident from an upper side of the liquid crystal panel 100R, that is, from the heat dissipation substrate 154 side, and the light is emitted from a lower side, that is, from the heat dissipation substrate 152 side. Note that light may be incident from the lower side of the liquid crystal panel 100R, that is, from the heat dissipation substrate 152 side, and the light may be emitted from the upper side, that is, from the heat dissipation substrate 154 side. In this configuration, the heat dissipation substrate 154 and the heat dissipation substrate 152 are configured to be respectively bonded to the light emitting surface of the counter substrate 104 and the light incident surface of the element substrate 102.

Further, thicknesses of the heat dissipation substrate 154, the counter substrate 104, the element substrate 102, and the heat dissipation substrate 152 are respectively indicated as t6, t2, t1, and t5 in this order, but specific numerical values are described later. When viewed in plan view (viewed from the upper surface side of the counter substrate 104 in FIG. 3 or 4), outer shapes of the heat dissipation substrates 152 and 154 are smaller than that of the counter substrate 104.

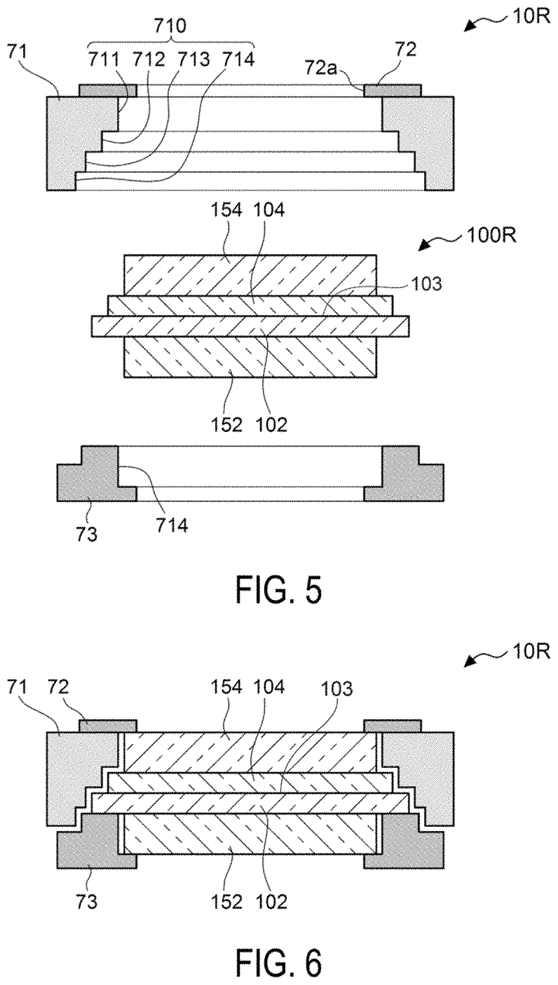

FIG. 5 is an exploded cross-sectional view illustrating a structure when the electro-optical device 10 in FIG. 2 is broken at the Aa-Ab line, and FIG. 6 is an assembled view of the electro-optical device 10 in FIG. 5.

In FIG. 5, the case 71 is made of metal or the like. A front plate 72 is provided on a light incident side in the case 71. The front plate 72 is made of a reflective metal such as aluminum, for example, and has a frame-shaped opening 72a as illustrated in FIGS. 5 and 6, and reflects light other than light made incident on the liquid crystal panel 100R, that is, light that does not contribute to the formation of a transmitted image.

Note that when viewed in plan view, the opening 72a is wider than an array region (not illustrated) of the pixel electrode in the liquid crystal panel 100R, and is narrower than the heat dissipation substrate 154.

A step 710 including wall portions 711, 712, 713, and 714 is provided on the inside of the case 71, that is, on the side where the liquid crystal panel 100R is housed. A part of the liquid crystal panel 100R is fitted onto this step 710. Specifically, the heat dissipation substrate 154 in a state of abutting the front plate 72 is fitted onto the wall portion 711. Similarly, the counter substrate 104 and the element substrate 102 are respectively fitted onto the wall portion 712 and the wall portion 713.

A rear plate 73 formed of a material such as metal having a high heat dissipation property such as aluminum is provided on the side of the case 71 where light is emitted. The rear plate 73 is fitted onto the element substrate 102 and the wall portion 714 of the case 71 to hold down the heat dissipation substrate 152.

Note that the case 71, the front plate 72, the liquid crystal panel 100R, and the rear plate 73 are fixed to each other with an adhesive or the like.

Cooling air by a fan (not illustrated) is applied to the liquid crystal panel 100R having such a configuration from the horizontal direction in FIG. 6. Since the dichroic prism 2112 is disposed on the emission side as illustrated in FIG. 1, a spatial margin is small. Thus, the amount of cooling air is greater on the incident side than on the emission side. As described above, a main heat generation source of the liquid crystal panel 100R is a black matrix in the element substrate 102, and thus heat created in the element substrate 102 is configured to be guided to the incident side via the case 71 to increase the cooling efficiency.

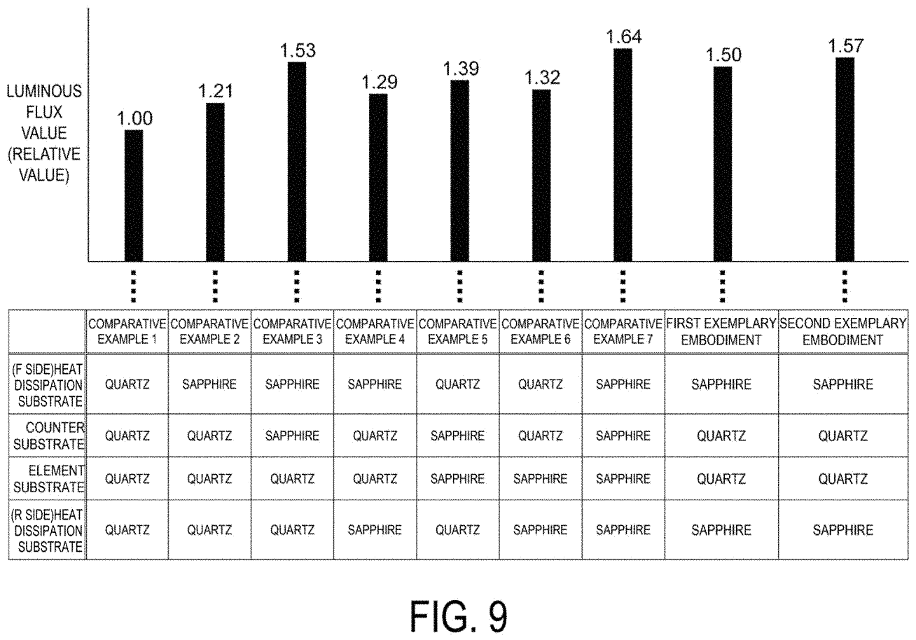

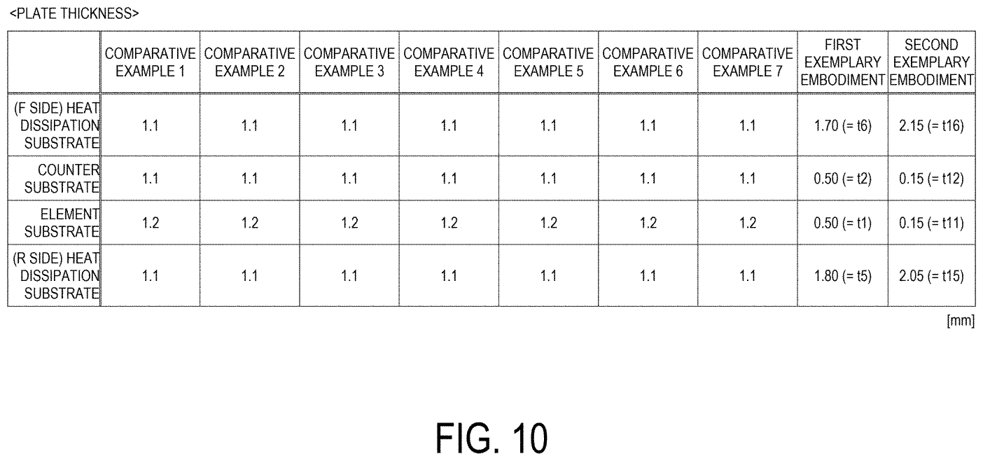

Here, in the liquid crystal panel 100R in the first exemplary embodiment, as illustrated in FIG. 9, a sapphire substrate is used for each of the heat dissipation substrates 152 and 154, and a quartz substrate is used for each of the element substrate 102 and the counter substrate 104. Further, in the liquid crystal panel 100R in the first exemplary embodiment, as illustrated in FIG. 10, the thickness t6 of the heat dissipation substrate 154 is 1.70 mm, the thickness t2 of the counter substrate 104 is 0.50 mm, the thickness t1 of the element substrate 102 is 0.50 mm, and the thickness t5 of the heat dissipation substrate 152 is 1.80 mm.

### Second Exemplary Embodiment

Next, a liquid crystal panel 100R according to a second exemplary embodiment will be described as an example. The liquid crystal panel 100R in the second exemplary embodiment is similar to that in the first exemplary embodiment in that a sapphire substrate is used for heat dissipation substrates 152 and 154, and a quartz substrate is used for each of an element substrate 102 and a counter substrate 104, but a thickness of each substrate differs from that of the first exemplary embodiment.

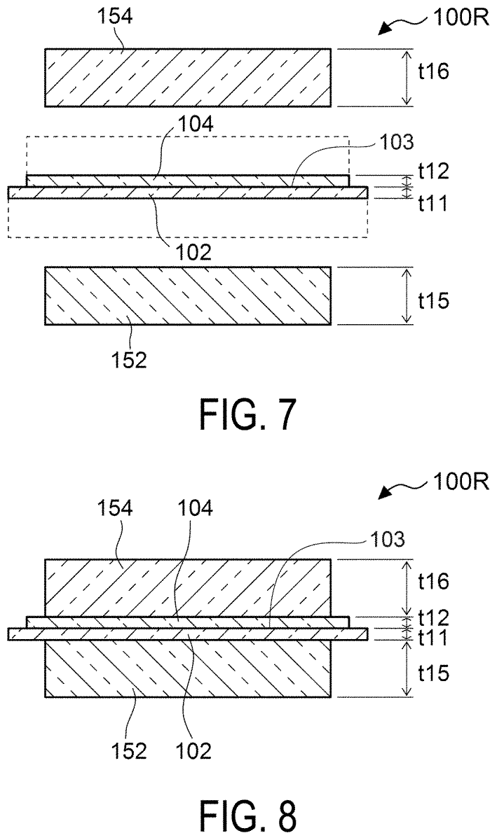

Specifically, as illustrated in FIG. 7, in the liquid crystal panel 100R in the first exemplary embodiment, first, in a state where the element substrate 102 and the counter substrate 104 are bonded together, the heat dissipation substrate 152 and the heat dissipation substrate 154 are configured to be respectively bonded to the element substrate 102 and the counter substrate 104, further as illustrated in FIG. 8. However, in the liquid crystal panel 100R in the second exemplary embodiment, when thicknesses of the heat dissipation substrate 154, the counter substrate 104, the element substrate 102, and the heat dissipation substrate 152 are indicated as t16, t12, t11, and t15 in this order, the thickness t16 is 2.15 mm, the thickness t12 is 0.15 mm, the thickness t11 is 0.15 mm, and the thickness t15 is 2.05 mm, as illustrated in FIG. 10.

Next, a point in that the material and the thickness of each of the substrates are adopted as described above in the liquid crystal panel 100R according to the first exemplary embodiment and the second exemplary embodiment will be described.

FIGS. 9 and 10 are diagrams for explaining superiority of the liquid crystal panel 100R according to the first exemplary embodiment and the second exemplary embodiment, and are diagrams for explaining a material and a thickness of each of the substrates as compared to the other comparative examples and the like. Specifically, FIG. 9 illustrates luminous flux values in liquid crystal panels and a material of each of the substrates according to Comparative Example 1 to Comparative Example 7 and the first exemplary embodiment and the second exemplary embodiment, and FIG. 10 illustrates a thickness of each of the substrates according to Comparative Example 1 to Comparative Example 7 and the first exemplary embodiment and the second exemplary embodiment.

Note that, in these examples, a total thickness of the liquid crystal panel 100R is equalized to be 4.5 mm. The reason is that, when a total thickness is different, an optical path length of the liquid crystal projector changes, and thus changes in overall optical design and the like are required.

The luminous flux value in the vertical axis in FIG. 9 is, in a case where a liquid crystal panel having a material and a thickness in the table is formed, a luminous flux value incident on the liquid crystal panel which causes a liquid crystal layer 103 to reach an allowable upper limit temperature, expressed as a relative value with a luminous flux value of the Comparative Example 1 as “1.00” being a reference. When a luminous flux value incident on the liquid crystal panel 100R is increased, characteristics of liquid crystals change, and thus a predetermined optical characteristic cannot be acquired. Therefore, the luminous flux value in FIG. 9 indicates how much the luminous flux value of possible upper limit incident on the liquid crystal panel configured as described above can be increased with reference to Comparative Example 1.

As illustrated in FIG. 9, when only the luminous flux values are observed, Comparative Example 3 and Comparative Example 7 are excellent.

However, as described above, a thin film transistor and the like are formed on the element substrate 102 by a high-temperature polysilicon manufacturing process at a temperature of 800° C. or higher, but when a sapphire (Al2O3) substrate is used, an Al component may not only contaminate a high temperature polysilicon manufacturing device, but also degrade a characteristic of the thin film transistor formed on the element substrate 102. A multilens array is formed on the counter substrate 104 in order to increase light-gathering power to a pixel, but since sapphire has a high refractive index, there is an inconvenience that the light-gathering efficiency cannot be increased, that is, a utilization efficiency of the light decreases.

Thus, in order to avoid such an inconvenience, a quartz substrate needs to be used for the element substrate 102 and the counter substrate 104. Therefore, Comparative Example 5 and Comparative Example 6 cannot be adopted in addition to Comparative Example 3 and Comparative Example 7. Note that, in Comparative Example 1 in which all of the substrates are a quartz substrate, the luminous flux value is low, and thus Comparative Example 1 cannot be adopted. Further, also in Comparative Example 2 in which only the heat dissipation substrate 154 is a sapphire substrate, the luminous flux value is low.

An improving trend in luminous flux values is seen in Comparative Example 4 in which a sapphire substrate is used for both of the heat dissipation substrates 152 and 154 as compared to Comparative Example 1 and Comparative Example 2. Therefore, it is considered preferable to use a sapphire substrate as each of the heat dissipation substrates 152 and 154.

Next, even when a sapphire substrate is used for the heat dissipation substrates 152 and 154, a configuration in which a plate thickness is simply increased cannot be adopted for design changes and the like due to an increase in optical path length, as described above. Thus, in the first exemplary embodiment and the second exemplary embodiment, after the element substrate 102 and the counter substrate 104 are bonded together and before the heat dissipation substrates 152 and 154 are bonded together, a thickness of the heat dissipation substrates 152 and 154 is ensured by thinning each of the light emitting surface of the element substrate 102 and the light incident surface of the counter substrate 104 by cutting, polishing, or the like.

Specifically, as in the first exemplary embodiment, a luminous flux value can be increased by setting a thickness of the heat dissipation substrate 152 and a thickness of the heat dissipation substrate 154 to be greater than or equal to two times a thickness of the element substrate 102 or a thickness of the counter substrate 104; setting a thickness of the element substrate 102 or a thickness of the counter substrate 104 to be less than or equal to 0.50 mm; setting a thickness of the heat dissipation substrate 152 and a thickness of the heat dissipation substrate 154 to be greater than or equal to 1.10 mm; and preferably setting a thickness of the heat dissipation substrate 152 and a thickness of the heat dissipation substrate 154 to be greater than or equal to three times a thickness of the element substrate 102 or a thickness of the counter substrate 104.

Further, as in the second exemplary embodiment, a luminous flux value can be increased further than that in the first exemplary embodiment by setting a thickness of the heat dissipation substrate 152 and a thickness of the heat dissipation substrate 154 to be greater than or equal to 10 times a thickness of the element substrate 102 or a thickness of the counter substrate 104; and preferably setting a thickness of the element substrate 102 and a thickness of the counter substrate 104 to be greater than or equal to 0.15 mm while setting a thickness of the heat dissipation substrate 152 and a thickness of the heat dissipation substrate 154 to be greater than or equal to 2.05 mm.

In this way, in the liquid crystal panel 100R according to the first exemplary embodiment and the second exemplary embodiment, the heat dissipation efficiency is increased, and a sufficient luminous flux value can be ensured. As a result, a brighter high luminance display can be achieved.

Further, in the liquid crystal panel 100R according to the first exemplary embodiment and the second exemplary embodiment, incident light of the lamp unit is focused on a pixel (liquid crystal layer 103), and a transmitted image thereof is projected onto the screen. By ensuring a thickness of the heat dissipation substrates 152 and 154, even if dust adheres to the incident surface of the heat dissipation substrate 152 or the emitting surface of the heat dissipation substrate 154, the dust is not focused, and thus an image of the dust can be prevented from being formed on the projection image.

Note that, in a configuration in which a thin film transistor and the like are formed after the element substrate 102 is thinned before bonding, not only changes in manufacturing conditions in the semiconductor manufacturing process are caused, but also an inconvenience that adversely affects display and the like is more likely to occur due to adhesion of dust created by cutting, polishing, or the like on the inner side surface facing the counter substrate 104.

Further, as the element substrate 102 and the counter substrate 104 are thinned, a thickness of the heat dissipation substrates 152 and 154 can be ensured. However, there is a limit to thinning of the element substrate 102 and the counter substrate 104. Specifically, when a thickness of the element substrate 102 and the counter substrate 104 is less than 0.15 mm, the substrate deforms, resulting in an occurrence of a problem in which transportation in the manufacturing process is difficult and warping, cracking, and the like also occur. Further, there is also a problem in which a failure is more likely to occur in crimping when one end of the FPC substrate 74 is coupled to the element substrate 102.

Thus, in the second exemplary embodiment, after the bonding, a thickness of the element substrate 102 or the counter substrate 104 is configured to be thinned with 0.15 mm as a limit.

What is claimed is:

1. An electro-optical device comprising:
a first quartz substrate;
a second quartz substrate facing the first quartz substrate;
a liquid crystal layer interposed between the first quartz substrate and the second quartz substrate;
a first sapphire substrate bonded to the first quartz substrate; and
a second sapphire substrate bonded to the second quartz substrate, wherein
the first sapphire substrate have a thickness greater than or equal to a thickness of n times a thickness of the first quartz substrate and the second sapphire substrate have a thickness greater than or equal to a thickness of n times a thickness of the second quartz substrate respectively, with the n being an integer of 2 or more.

2. The electro-optical device according to claim 1, wherein
the thickness of the first quartz substrate and the thickness of the second quartz substrate each are 0.50 mm or less, and
the thickness of the first sapphire substrate and the thickness of the second sapphire substrate each are at least 1.10 mm.

3. The electro-optical device according to claim 2, wherein the n is an integer of 3 or more.

4. The electro-optical device according to claim 3, wherein the thickness of the first sapphire substrate and the thickness of the second sapphire substrate each are at least 1.70 mm.

5. The electro-optical device according to claim 4, wherein the n is at least 10 times.

6. The electro-optical device according to claim 5, wherein
the thickness of the first quartz substrate and the thickness of the second quartz substrate each are at least 0.15 mm, and
the thickness of the first sapphire substrate and the thickness of the second sapphire substrate each are at least 2.05 mm.

7. A method for manufacturing an electro-optical device comprising:
bonding a first quartz substrate and a second quartz substrate together, with a liquid crystal layer interposed therebetween;
thinning the first quartz substrate by cutting or polishing;
thinning the second quartz substrate by cutting or polishing;
bonding a first sapphire substrate to the first quartz substrate; and
bonding a second sapphire substrate to the second quartz substrate, wherein
the first sapphire substrate and the second sapphire substrate have a thickness that is at least n times a thickness of the first quartz substrate and a thickness that is at least n times a thickness of the second quartz substrate respectively, with n being an integer of 2 or more.

8. A projector comprising the electro-optical device according to claim 1.
